(19) United States
(12) Patent Application Publication
(10) Pub. No.: US 2016/0040899 A1
(43) Pub. Date: Feb. 11, 2016

(54) ACTUATED VENT

(71) Applicant: Ronald Lee, San Jacinto, CA (US)

(72) Inventor: Ronald Lee, San Jacinto, CA (US)

(73) Assignee: Nadine Barlow, San Jacinto, CA (US)

(21) Appl. No.: 14/612,161

(22) Filed: Feb. 2, 2015

Related U.S. Application Data
(60) Provisional application No. 61/910,673, filed on Dec. 2, 2013.

(51) Int. Cl. F24F 11/00; F16K 37/00

(52) U.S. Cl. CPC F24F 11/001; F16K 37/00; F24F 11/0076; F24F 11/0012; F24F 2011/0056; F24F 2011/0057; F24F 2011/0068

(57) ABSTRACT

Disclosed is a system for controlling temperature of an area via vents. In one embodiment, the areas/rooms of a building that are substantially isolated from one another may require or benefit from temperature that are different from other areas/rooms. Accordingly, the system includes an actuator that is coupleable to a valve structure of a vent. The fluid flow upstream of the vent may be conditioned by a climate control system, such as a furnace. The system of the present disclosure further includes a controller that is coupleable in communication with the actuator. The controller is configured to receive a vent input and send a command signal to the actuator based on the vent input. The vent input is a desired position of the valve structure of the vent and the controller is independent of the climate control system.

### CROSS-REFERENCES TO RELATED APPLICATIONS

This application claims the benefit of U.S. Provisional Patent Application No. 61/910,673 entitled “REMOTE/THERMOSTAT CONTROLLED VENT FOR A BUILDING” and filed on Dec. 2, 2013 for Ronald Lee, which is incorporated herein by reference.

### FIELD

This invention temperature control systems and more particularly relates to vent control systems.

### BACKGROUND

Cost-effective climate control in a building, such as a large commercial building, can be challenging, especially in view rising energy costs increased regulation regarding energy use. Conventionally, air is temperature conditioned, using a heat pump climate control system and/or a combustion climate control system (among other types) and then distributed through a building via ducts. The conditioned air is then dispersed into the various areas/regions of the building via vents. While certain types of vents include vanes that may be manually altered in order to affect the flow of air, conventional climate control and duct systems generally fail to effectively and accurately provide desired (e.g., uniform) temperature modification in each of the various areas/regions of the building.

### SUMMARY

From the foregoing discussion, it should be apparent that a need exists for a vent system that increases the efficiency and/or accuracy of modifying the temperature in an area that relies on forced air climate control systems. The subject matter of the present application has been developed in response to the present state of the art, and in particular, in response to the problems and needs in the art that have not yet been fully solved by currently available climate control systems. Accordingly, the present disclosure has been developed to provide a vent system that overcomes many or all of the above-discussed shortcomings in the art.

Disclosed herein is one embodiment of a system for controlling temperature of an area via vents. In one embodiment, the areas/rooms of a building that are substantially isolated from one another may require or benefit from temperature that are different from other areas/rooms. Accordingly, the system includes an actuator that is coupleable to a valve structure of a vent. The fluid flow upstream of the vent may be conditioned by a climate control system, such as a furnace. The system of the present disclosure further includes a controller that is coupleable in communication with the actuator. The controller is configured to receive a vent input and send a command signal to the actuator based on the vent input. The vent input is a desired position of the valve structure of the vent and the controller is independent of the climate control system.

According to one implementation, vent is an existing vent and the actuator is retrofitably coupleable to the valve structure of the existing vent. In another implementation, the vent input received by the controller is based on a user selected fluid flow rate. The vent input may be based on a user selected set-point schedule. In one implementation, the system further includes a temperature sensor. The temperature sensor detects an actual temperature of fluid downstream of the vent and therefore the vent input may be based on the actual temperature detected by the temperature sensor.

In one implementation, the vent input is determined by comparing the actual temperature to a desired temperature threshold. In another implementation, the fluid flow upstream of the vent is forced-air that flows through ducts. The controller may be coupleable in communication with the actuator of a single vent or the controller may be coupleable in communication with a plurality of actuators, with the plurality of actuators being coupleable to a plurality of vents. In one implementation, the controller and the actuator are wirelessly coupleable in communication. For example, the controller and the actuator may be coupleable in communication across a network (such as a local Wi-Fi network) or via radio signal.

In one implementation, the controller is housed within a hand-held remote control device. In another implementation, the controller may be a wall-mounted device. The actuator may include a motor that is configured to rotate panes of the valve structure between an open and a closed position. For example, the motor may be configured to position the panes of the valve structure in various intermediate positions between the open and the closed position.

Also disclosed herein is one embodiment of a method for controlling temperature. The method includes receiving vent input and sending a command signal to an actuator based on the vent input, wherein the actuator is coupled to a valve structure of a vent. Fluid flow upstream of the vent is conditioned by a climate control system and the vent input includes a desired position of the valve structure of the vent. According to one implementation, the method further includes receiving an actual temperature of fluid downstream of the vent and therefore the vent input is based on the actual temperature.

Also disclosed herein is one embodiment of a computer program product that includes a storage device storing machine readable code executed by a processor to perform operations. The operations include receiving vent input and sending a command signal to an actuator based on the vent input, with the actuator being coupled to a valve structure of a vent. The fluid flow upstream of the vent is conditioned by a climate control system and the vent input is a desired position of the valve structure of the vent. According to one implementation, the computer program product further includes the operations of receiving an actual temperature of fluid downstream of the vent, wherein the vent input is based on the actual temperature.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a front view of a vent with an actuator (schematically depicted) coupled to the vent and a controller (schematically depicted) coupled in communication with the actuator, according to one embodiment;

FIG. 2A is a side cross-sectional view of a valve structure of a vent in a substantially closed position, according to one embodiment;

FIG. 2B is a side cross-sectional view of the valve structure of the vent of FIG. 2A in a partially open position, according to one embodiment;

FIG. 2C is a side cross-sectional view of the valve structure of the vent of FIG. 2B in a fully open position, according to one embodiment;

FIG. 3 is a front view of a wall-mounted controller device, according to one embodiment;

FIG. 4 is a perspective view of a hand-held controller device, according to one embodiment;

FIG. 5A is a schematic flow chart diagram of a method for controlling temperature, according to one embodiment; and

FIG. 5B is a schematic flow chart diagram of a method for controlling temperature, according to another embodiment.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

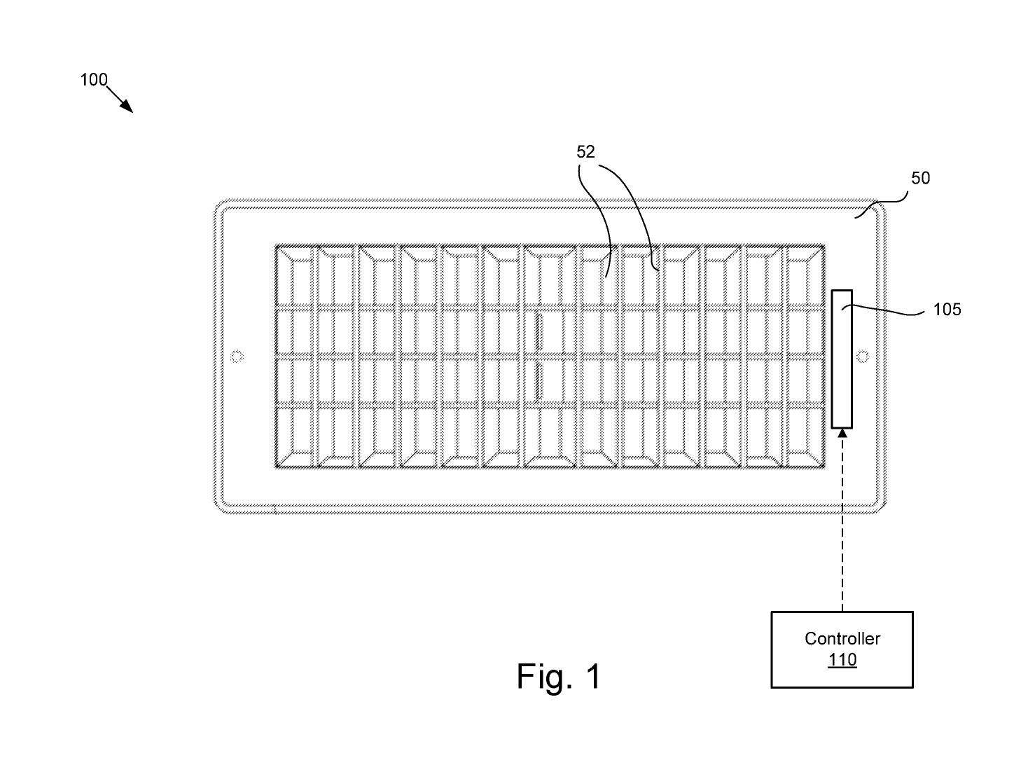

FIG. 1 is a front view of a vent 50 with an actuator (schematically depicted) 105 coupled to the vent 50 and a controller (schematically depicted) 110 coupled in communication with the actuator 105, according to one embodiment. The present disclosure relates generally to auxiliary temperature control for certain zones/regions of a building. Conventional climate control systems, such as a furnace/heat pump with associated ductwork, generally involve blowing and dispersing conditioned air throughout a building until a desired building temperature is reached. While such systems provide overall building temperature control, in certain applications it may be beneficial to alter and control the temperature of certain areas (e.g., regions, rooms, etc.) of the building without changing the overall climate control system. In other words, the present disclosure relates to a vent system that regulates and controls the temperate of certain areas/rooms of a building independent of an existing/conventional climate control system (such as a furnace or HVAC system).

In one embodiment, one or more actuators 105 may be coupled to a vent 50. The vent 50 may be a conventional vent that is disposed at a terminating end of a section of ductwork through which air exits the ductwork into a region/room of a building. The actuator 105 may include a motor and may be electromechanically controlled. For example, the vent 50 may include a valve structure 52, such as rotatable vanes/panes, that alter the direction and/or flow rate of the fluid passing through the vent 50. The actuator 105 may be coupled to the valve structure 52 (defined herein as the components of the vent that are adjustable to control fluid flow) and may receive command signals from the controller 110 relating to the position of the valve structure 52. Additional details relating to the controller 110, the actuator 105, and the vent 50 are included below with reference to the remaining figures.

In one embodiment, the actuator 105 includes a motor that is powered by electricity, hydraulics, or pneumatics, depending on the size and weight of the valve structures 52 of the vent 50. The motor may be powered by household current and/or batteries (rechargeable or disposable). While the actuator 105 is depicted schematically in FIG. 1, the actuator 105 may be coupled directly to internal the valve structure 52 of the vent 50. As described below, the actuator is communication coupled (i.e., via hardwire or wireless communication) to the controller 110 and/or may be connected to a network. Multiple motors of the same type or different types, controlling multiple vents, may be controlled by the same controller. As described below, the controller 110 may be housed within a variety of different control devices, such as hand-held devices or wall-mounted devices.

The motor of the actuator 105 may be manufactured from rigid, durable materials such as steel, brass, aluminum, composite, plastic, etc. Further, the control devices may be manufactured from rigid, durable materials such as high-impact plastic, aluminum, steel, and brass, among others. The size, dimensions, and weight of the actuator 105 and/or the control device (housing the controller) may vary according to the specifics of a given application.

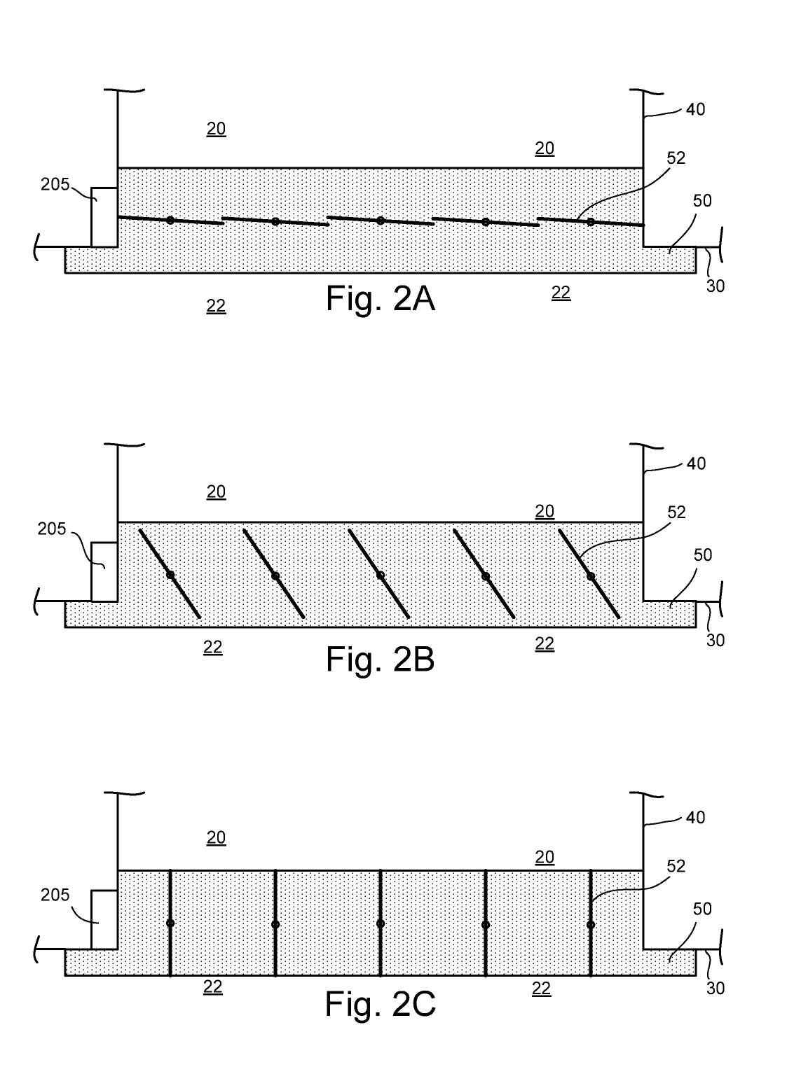

FIGS. 2A-2C are side cross-sectional views of a valve structure 52 of a vent in various positions. FIG. 2A shows the valve structure 52 in a substantially closed position, FIG. 2B shows the valve structure 52 in a partially open position, and FIG. 2C shows the valve structure 52 in a fully open position. As described above, the term “valve structure 52” is defined herein as the components or parts of the vent 50 that are rotatable/adjustable and that affect the flow rate of the fluid. As seen in FIG. 2A, the vanes/panes are substantially closed and little to no fluid exits through the vent 50. FIG. 2B, however, shows the vent 50 with the panes/vanes in a partially open position, thereby letting an intermediate volume of fluid to flow through the vent from the upstream 20 side to the downstream side 22. Finally, FIG. 2C shows the vanes/panes completely open, thereby allowing the maximum volume of fluid to flow through the vent 50.

In one embodiment, the air flows through a ducted ventilation systems (see duct 40), and provides an electromechanical solution to the opening and closing of vents 50. As depicted, the vent 50 may include a flange that engages an interior surface 30 of a building. While the system may be primarily implemented with internal vents which are part of a full building ventilation system, in other embodiments the vent system may be used with any vent on a building or similar structure.

Also, the amount of closure (i.e., the position of the vanes) of the valve structure 52 of the vents 50 may be discrete or step-like, thus allowing the vent 50 to occupy various, predetermined positions that correspond to discrete flow-rates. In another embodiment, the transition between open and closed may be continuous, thus allowing the actuator 205 to position the valve structure of the vent in any intermediate position.

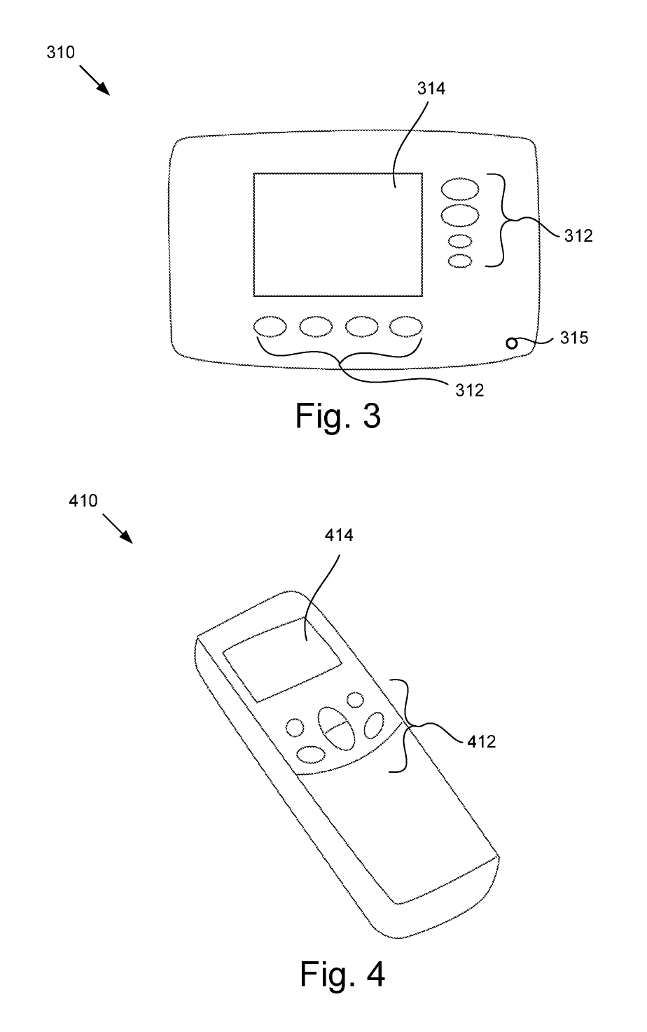

FIG. 3 is a front view of a wall-mounted controller device 310, according to one embodiment, and FIG. 4 is a perspective view of a hand-held controller device 410, according to one embodiment. As described above, the controller may be housed within a controller device 310, 410. In one embodiment, the controller device 310, 410 may have a user interface that includes various buttons 312, 412 and a display 314, 414. Thus, in one embodiment a user may be able to manually enter information into the controller device (received by the controller as vent input) and the controller device may then be able to communicate such input to the actuator in the form of command signals. As described above, the actuator and the controller (e.g., controller device) may communicate via a hard-wire connection, a wireless connection (such as an RF signal or the like), or over a network. In one embodiment, the controller may be implemented as an application (“App”) on a smartphone or as a website that a user may navigate to. Accordingly, the user may be able to control the actuator that is coupled to the vent remotely via the App/website.

The system may further include a temperature sensor 315. The temperature sensor may monitor the temperature of the area/region/room and the temperature sensor may report the actual/measured temperature to the controller. Once the controller receives the actual temperature, the controller may determine a vent input based on the actual temperature. For example, the controller may compare the actual temperature of the room to a desired/set temperature threshold. The vent input may accordingly be determined based on the magnitude of error between the actual temperature and the set point temperature. Thus, the controller may be configured to provide automatic/programmable temperature control to the room.

For example, the temperature sensor, such as a thermostat, in conjunction with and via the controller, may be configured to open and close particular vents based on a combination of the following parameters: time schedule, day of the week, actual temperature, desired temperature, number of occupants within the room, and changes to building external temperature, etc. The controller may further be configured to establish a local temperature control scheme for each room. In a further example, as the actual temperature approaches the desired temperature within the room (error decreases), the controller may gradually close the valve structure of the vent in order to prevent temperature overshoot and to maximize the efficiency and accuracy of the temperature control within the room. Alternatively, the vents may just be completely closed when the selected temperature is reached.

In one embodiment, a single controller may communicate with multiple actuators across multiple vents in the same room. For example, each room may have its own controller, regardless of how many vents are in the room. In another embodiment, a single controller may communicate and control the vents in multiple rooms. For example, the actuated vents in two separate rooms may be controlled in a coordinated fashion, thus taking into account the changes to each of the vents in the rooms and how such changes will affect other/adjacent rooms.

In one specific embodiment, a remote control may include two or more buttons (such as a reversible switch) which are used to control the actuator. The remote control may include means for communicating with the actuator(s), such as a radio frequency (RF) transmitter (and a corresponding RF receiver on the actuator), a microprocessor and a memory device. The remote control may be capable of sending two encoded signals to the RF receiver in the actuator, corresponding to the actions of opening and closing the vent. If such a signal is received by the RF receiver, the signal is compared to a record of appropriate signals stored on the memory device for authentication. If the transmitted signal matches the recorded signal, the appropriate action is performed by the motor.

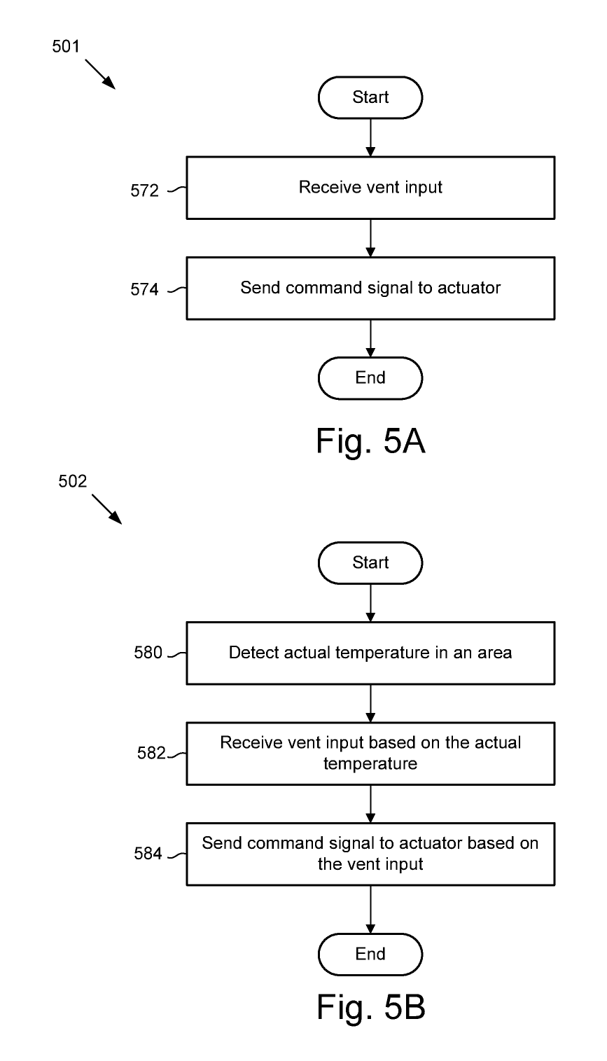

FIG. 5A is a schematic flow chart diagram of a method 501 for controlling temperature, according to one embodiment, and FIG. 5B is a schematic flow chart diagram of another embodiment of a method 502 for controlling temperature. The method 501 of FIG. 5A includes receiving vent input at 572 and sending a command signal at 574. As described above, the vent input may be user selected vent parameters or the vent input may be calculated based on actual temperature received 580 via a temperature sensor, etc. The command signal sent to the actuator is based on the vent input. For example, the command signal may be a voltage or a current that effectuates a respective change in the valve structure of the vent (i.e., the actuator changes the flow rate through the vent).

Accordingly, the disclosure is directed to an electromechanically controlled actuator that is coupled to or integrated with a vent. The vent may be part of a duct system in a residential building, a commercial building, an industrial building, or another type of building. The actuator is controlled via a controller that operates independently of the building's conventional climate control system, thus providing auxiliary, backup, or a low energy solution to temperature maintenance/control. The vent is opened or closed by the actuator upon the actuator receiving the command signal, which is dependent on the vent input. The vent input and/or the command signal may be transmitted via hard-wires, radio signals, mobile data networks, Bluetooth, local Wi-Fi networks, or other communication platforms.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. Where a module or portions of a module are implemented in software, the program code may be stored in one or more computer readable medium(s).

The computer readable medium may be a tangible or non-transitory computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible or non-transitory medium (e.g., volatile memory or storage medium, non-volatile memory or storage medium) that can contain, and/or store program code for use by and/or in connection with an instruction execution system, apparatus, or device.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
an actuator coupleable to a valve structure of a vent, wherein fluid flow upstream of the vent is conditioned by a climate control system; and
a controller coupleable in communication with the actuator, the controller configured to receive a vent input and send a command signal to the actuator based on the vent input, the vent input comprising a desired position of the valve structure of the vent, wherein the controller is independent of the climate control system.

2. The system of claim 1, wherein the vent is an existing vent and the actuator is retrofitably coupleable to the valve structure of the existing vent.

3. The system of claim 1, wherein the vent input received by the controller is based on a user selected fluid flow rate.

4. The system of claim 1, wherein the vent input is based on a user selected set-point schedule.

5. The system of claim 1, further comprising a temperature sensor, wherein the temperature sensor detects an actual temperature of fluid downstream of the vent, wherein the vent input is based on the actual temperature.

6. The system of claim 4, wherein the vent input is determined by comparing the actual temperature to a desired temperature threshold.

7. The system of claim 1, wherein the fluid flow upstream of the vent comprises forced-air flow via ducts.

8. The system of claim 1, wherein the controller is coupleable in communication with the actuator of a single vent.

9. The system of claim 1, wherein the controller is coupleable in communication with a plurality of actuators, wherein the plurality of actuators are coupleable to a plurality of vents.

10. The system of claim 1, wherein the controller and the actuator are wirelessly coupleable in communication.

11. The system of claim 1, wherein the controller and the actuator are coupleable in communication across a local wi-fi network.

12. The system of claim 1, wherein the controller comprises a hand-held remote control device.

13. The system of claim 1, wherein the controller comprises a wall-mounted device.

14. The system of claim 1, wherein the actuator comprises a motor configured to rotate panes of the valve structure between an open and a closed position.

15. The system of claim 14, wherein the motor is configured to position the panes of the valve structure in various intermediate positions between the open and the closed position.

16. A method comprising:
receiving vent input; and
sending a command signal to an actuator based on the vent input, wherein the actuator is coupled to a valve structure of a vent, wherein fluid flow upstream of the vent is conditioned by a climate control system, wherein the vent input comprises a desired position of the valve structure of the vent.

17. The method of claim 16, further comprising receiving an actual temperature of fluid downstream of the vent, wherein the vent input is based on the actual temperature.

18. A computer program product comprising a storage device storing machine readable code executed by a processor to perform the operations of:
receiving vent input; and
sending a command signal to an actuator based on the vent input, wherein the actuator is coupled to a valve structure of a vent, wherein fluid flow upstream of the vent is conditioned by a climate control system, wherein the vent input comprises a desired position of the valve structure of the vent.

19. The computer program product of claim 18, further comprising operations for receiving an actual temperature of fluid downstream of the vent, wherein the vent input is based on the actual temperature.

20. The computer program product of claim 19, wherein the computer program product is stored on memory of a hand-held computing device.
